(19) United States
(12) Patent Application Publication
(10) Pub. No.: US 2021/0078359 A1
(43) Pub. Date: Mar. 18, 2021

(54) PAINT ROLLER CLEANING APPARATUS

(71) Applicant: James Michael Archetto, Norton, MA (US)

(72) Inventor: James Michael Archetto, Norton, MA (US)

(21) Appl. No.: 16/948,382

(22) Filed: Sep. 16, 2020

Related U.S. Application Data
(60) Provisional application No. 62/901,347, filed on Sep. 17, 2019.

(51) Int. Cl. B44D 3/00

(52) U.S. Cl. CPC B44D 3/006

(57) ABSTRACT

A paint roller washing device provides a containment chamber adapted to removably secure therein the roller portion of a paint roller. The roller washing device also provides fluid channel adapted to direct a supply of pressurized fluid tangentially along a circumference of the roller portion, causing the roller portion to spin at a high rate of speed, thereby spinning the paint off the roller due to the centrifugal force, while also spraying paint off the tangentially struck circumference. The supply of pressurized water may be an external garden hose that fluidly connects to the fluid channel by way of a fluid jacket along an outer surface of the containment chamber, which also provides a slot for securing the frame portion of the paint roller while the roller portion is subject to a blade of pressured fluid.

### CROSS-REFERENCE TO RELATED APPLICATION

This application claims the benefit of priority of U.S. provisional application No. 62/901,347, filed 17 Sep. 2019, the contents of which are herein incorporated by reference.

### BACKGROUND OF THE INVENTION

The present invention relates to painting equipment and, more particularly, a device for cleaning paint rollers through contained pressure washing.

After a paint roller is used to paint a surface, the roller is laden with paint. This paint must be washed from the roller in order to clean the roller prior to either reuse in the application of a different color of paint or storage. The processes currently used to clean paint rollers can be ineffective, time-consuming, messy, and wasteful in terms of the water used. Given that painting large surfaces areas (where paint rollers are most applicable) is typically a time sensitive project, the conventional approach to washing/cleaning paint rollers can be problematic. Likewise, since paint rollers can cost up to $20, replacing a paint roller with each application is prohibitively expensive. Unfortunately, current paint-roller cleaning devices are complex, expensive, and tend to be messy affairs, splattering paint.

Thus, there is a need for a simple, neat, cost effective device for cleaning paint rollers. The present invention embodies a method of cleaning a paint roller with a blade of pressured water adapted to hit the roller tangentially causing it to spin at a high velocity in a containment chamber. The process removes the paint from the roller in two ways: first, directly at the location where the blade of pressured water impacts the roller; and second, over the entirety of the roller through centrifugal force generated by the rotation of the roller. The device is self-contained and has no additional moving parts through the use of a fluid channel operatively associated with a supply of pressurized fluid, wherein the fluid channel directs a blade of pressurized fluid at the roller secured in the containment chamber. Additionally, the present invention directs the removed paint to a receptacle below the containment chamber, in an environmentally responsible, cost-effective manner.

### SUMMARY OF THE INVENTION

In one aspect of the present invention, an apparatus including a tubular housing extending from a top end to a bottom end; a fluid channel fluidly communicating a lumen of the tubular housing with an exterior of the tubular housing; and the fluid channel configured to urge a regulated pressurized fluid to form a blade of fluid, wherein a height of the blade of fluid is at least equal to the length of a paint roller; a securing groove communicating with the top end, wherein the securing groove has a horizontal portion parallel with the top end, wherein the securing groove defines a void of one quarter of an inch to one inch in width; a handle lock adjacent a distal end of the horizontal portion, wherein the fluid channel fluidly connects to a pressurized fluid supply, and wherein the blade of fluid has an elongated cross section having at least a 20 to 1 length to width ratio.

In another aspect of the present invention, a system of cleaning a paint roller, the system including the following: an apparatus comprising: a tubular housing extending from a top end to a bottom end; a fluid channel fluidly communicating a lumen of the tubular housing with an exterior of the tubular housing; the fluid channel configured to urge a pressurized fluid to form a blade of fluid, wherein a height of the blade of fluid is at least equal to a length of the paint roller; and a securing groove communicating with the top end, wherein the securing groove has a horizontal portion parallel with the top end, and wherein the securing groove defines a void dimensioned to slidably receive a frame of the paint roller; a handle lock adjacent a distal end of the horizontal portion, wherein the blade of fluid is directed to tangentially strike a circumference of the paint roller supported by said frame via the securing groove, and wherein the blade of fluid tangentially strikes along said length of the paint roller, wherein the blade of fluid has an elongated cross section, the elongated cross section having at least a 20 to 1 length to width ratio. In certain embodiments, the length of the blade of fluid may be six to sixteen inches.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention shown in use;

FIG. 2 is a perspective view of an exemplary embodiment of the present invention, with parts broken away for clarity;

FIG. 3 is a top plan view of an exemplary embodiment of the present invention, indicated by line 3-3 of FIG. 2;

FIG. 4 is a section view of an exemplary embodiment of the present invention, taken along line 4-4 of FIG. 3; and

FIG. 5 is a section view of an exemplary embodiment of the present invention, taken along line 5-5 of FIG. 3.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a paint roller washing device. The roller washing device provides a containment chamber adapted to removably secure therein the roller portion of a paint roller. The roller washing device also provides fluid channel adapted to direct a supply of pressurized fluid tangentially along a circumference of the roller portion, causing the roller portion to spin at a high rate of speed, thereby spinning the paint off the roller due to the centrifugal force, while also spraying paint off the tangentially struck circumference. The supply of pressurized water may be an external garden hose that fluidly connects to the fluid channel by way of a fluid jacket along an outer surface of the containment chamber, which also provides a slot for securing the frame portion of the paint roller while the roller portion is subject to a blade of pressured fluid.

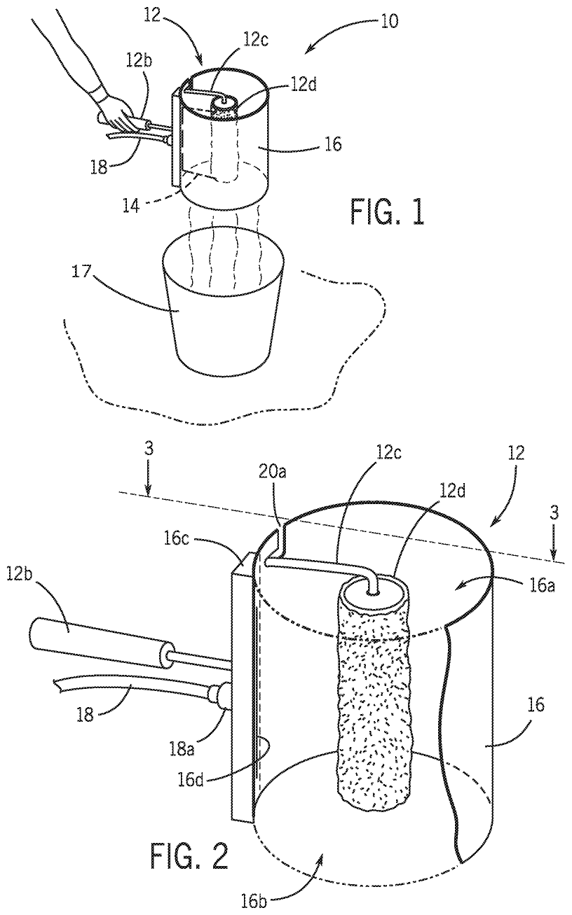

Referring now to FIGS. 1 through 5, the present invention may include a washing device 10 for cleaning a roller 12d of a paint roller 12. The washing device 10 may provide a tubular housing 16 extending between a first end and a second end. The first end may define an observation opening 16a, while the second end defines a drain opening 16b. The drain opening 16b may be located over a fluid collector 17 to efficiently capture the draining fluid and removed paint during use in an environmentally responsible, cost-effective manner. The observation opening 16a facilitates a user overseeing operation.

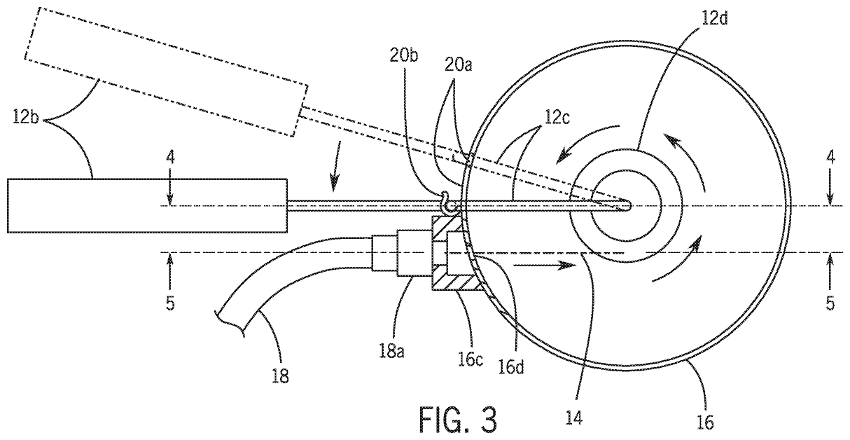

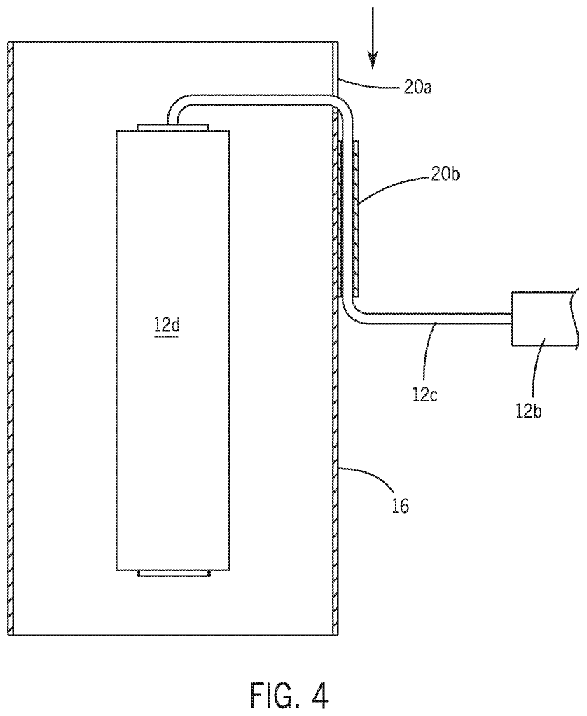

The first end may communicate with a securing groove 20a, such as a J-channel, dimensioned and adapted to receive the roller frame 12c of the paint roller 12 so that the roller 12d is disposed in the lumen of the tubular housing 16 while the handle 12b is disposed outside of the tubular housing 16, as illustrated in the FIGS. Note, even though the FIGS. show a J-channel, the securing groove 20a can be other shapes are long as it functions as disclosed herein. A clip lock 20b dimensioned and adapted to engage a portion of the roller handle 12b outside the tubular housing 16 may be provided along an exterior surface thereof. The clip lock 20b can be engaged and disengaged by moving the roller handle 12b along a horizontal portion of the securing groove 20a, as illustrated in FIG. 3. It should be understood, that the clip lock 20b may be any locking mechanism that can cooperate with the securing groove 20a as disclosed herein—i.e., it need not have a clip like shape/functionality.

A fluid jacket 16c may extend along an exterior surface of the tubular housing 16. The fluid jacket 16c fluidly interconnects an external pressurized fluid supply 18 and a fluid channel 16d communicating with the lumen of the tubular housing 16. The fluid supply 18 may be connected to the fluid jacket 16c by a fluid connection 18a. The pressurized fluid supply 18 may be a garden hose, in certain embodiments.

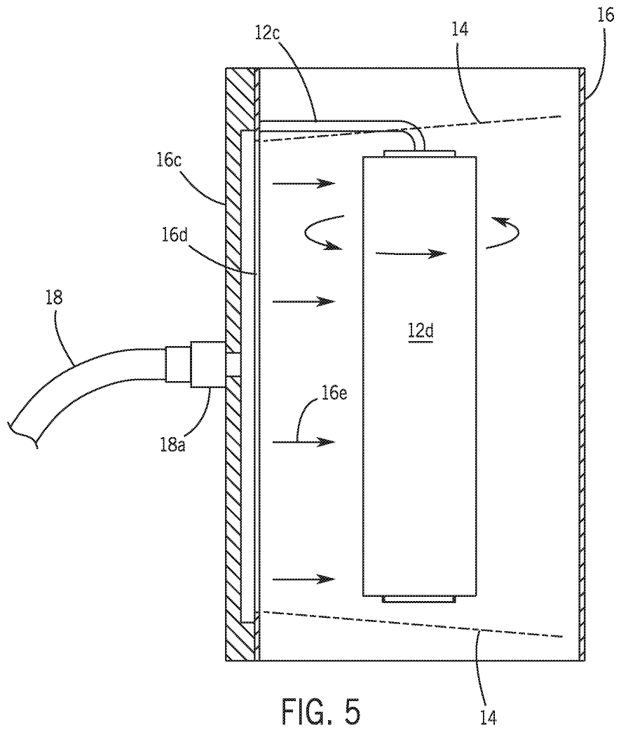

The fluid channel 16d alters the direction of flow, shape and velocity of the pressurized fluid delivered by the fluid supply 18. In one embodiment, the fluid channel 16d urges a fluid blade 14 having the trajectory 16e illustrated in FIG. 5. The fluid blade 14 has a cross-sectional height of at least as long or longer than a longitudinal length of the roller 12d.

A method of making the present invention may include the following. A manufacturer may procure a pipe of a specified diameter and thickness to be cut to specified length, thereby forming the tubular housing 16. A longitudinally cut capped tube or equivalent may act as the fluid jacket 16c and be adhered to the tubular housing 16 via a water-tight adhesive seal. The fluid connection 18a may be adhered to the fluid jacket 16c for fluidly coupling the pressurized fluid supply 18 thereto. The securing groove 20a may be cut into the first end of the tubular housing 16 to accommodate engagement of the paint roller frame 12c during operation.

The fluid channel 16d may be cut or machined into the tubular housing 16 to allow high velocity/pressure fluid to pass through the fluid channel 16d into the lumen of the tubular housing 16 in the form of the above mentioned fluid blade 14 with the above-mentioned trajectory 16e. The location of the fluid channel 16d relative to the securing groove 20a may vary but is critical that the fluid blade 14 tangentially strike the circumference of the secured roller 12d.

Alternatively, the device may be molded to provide the requisite functionality.

A method of using the present invention may include the following. The roller washing device 10 disclosed above may be provided. A user may place the roller frame 12c of a paint-laden roller in the securing groove 20a until the frame 12c secures to the clip lock 20b. Then the user may place the tubular housing 16 over the fluid collector 17 or a drain. With the roller frame 12c of the paint laden roller secured in the clip lock 20b, the user may then fluidly connect the pressurized fluid supply 18 to the water jacket 16c by way of the fluid connection 18a. When the fluid supply 18 delivers pressurized fluid into the fluid jacket 16c/manifold, the fluid is urged through the high-velocity fluid channel 16d, which directs and shapes the fluid into the fluid blade 14 tangentially striking the circumference of the roller 12d, making the roller 12d rotate about an axial portion of the roller frame 12c. This in turn causes rotation at a high rate of speed that flings the paint off the roller 12d by way of centrifugal force. The fluid also dilutes and knocks off paint it comes in direct contact with. When the fluid supply 18 is turned off, the roller 12d will continue spinning and spin off excess fluid, thereby partially drying the roller 12d.

It should be understood, of course, that the foregoing relates to exemplary embodiments of the invention and that modifications may be made without departing from the spirit and scope of the invention as set forth in the following claims.

What is claimed is:

1. An apparatus comprising:
a tubular housing extending from a top end to a bottom end;
a fluid channel fluidly communicating a lumen of the tubular housing with an exterior of the tubular housing; and
the fluid channel configured to urge a pressurized fluid to form a blade of fluid, wherein a height of the blade of fluid is at least having at least a 20 to 1 length to width ratio.

2. The apparatus of claim 1, further comprising a securing groove communicating with the top end, wherein the securing groove has a horizontal portion parallel with the top end.

3. The apparatus of claim 2, wherein the securing groove defines a void of half an inch to one inch in width.

4. The apparatus of claim 3, further comprising a handle lock adjacent a distal end of the horizontal portion.

5. The apparatus of claim 4, wherein the fluid channel fluidly connects to a pressurized fluid supply.

6. The apparatus of claim 5, wherein the blade of fluid has an elongated cross section.

7. A system of cleaning a paint roller, the system comprising:
an apparatus comprising:
a tubular housing extending from a top end to a bottom end;
a fluid channel fluidly communicating a lumen of the tubular housing with an exterior of the tubular housing;
the fluid channel configured to urge a pressurized fluid to form a blade of fluid, wherein a height of the blade of fluid is at least equal to a length of the paint roller; and
a securing groove communicating with the top end, wherein the securing groove has a horizontal portion parallel with the top end, and wherein the securing groove defines a void dimensioned to slidably receive a frame of the paint roller.

8. The system of claim 7, further comprising a handle lock adjacent a distal end of the horizontal portion.

9. The system of claim 8, wherein the blade of fluid is directed to tangentially strike a circumference of the paint roller supported by said frame via the securing groove, and wherein the blade of fluid tangentially strikes along an said length of the paint roller.

10. The system of claim 9, wherein the blade of fluid has an elongated cross section having at least a 20 to 1 length to width ratio.
